(19) United States
(12) Patent Application Publication
(10) Pub. No.: US 2006/0262000 A1
(43) Pub. Date: Nov. 23, 2006

(54) PORTABLE CONTROLLER FOR OPERATING A DEVICE FROM A REMOTE LOCATION

(76) Inventor: Russell W. Strong, Craftsbury Common, VT (US)

Correspondence Address: ARTZ & ARTZ, P.C., 28333 TELEGRAPH RD., SUITE 250, SOUTHFIELD, MI, 48034, US

(21) Appl. No.: 11/419,614

(22) Filed: May 22, 2006

Related U.S. Application Data
(60) Provisional application No. 60/684,847, filed on May 20, 2005.

(51) Int. Cl. G08C 19/12; H04L 17/02

(52) U.S. Cl. 341/176

(57) ABSTRACT

A portable remote controller is disclosed herein. The remote controller is useful with a vehicle or other controlled device so that an operator can run all primary functions therewith from one hand while doing something else with the other hand. In some embodiments, the remote controller is readily dockable for storage, working with other applications, positioning and operation in a fixed remote location, or able to be passed to someone else for like usage.

### CROSS REFERENCE TO RELATED APPLICATION(S)

The present invention claims priority from U.S. Provisional Application Ser. No. 60/684,847, originally entitled “Hand-Held Controller for Remote Operations,” which was filed on May 20, 2005.

### FIELD OF THE INVENTION

The present invention generally relates to a remote controller for a vehicle system that may relate to utility, commercial, or military applications wherein an operator desires a conveniently small controller unit that can be used readily for one-handed operation of one or more control elements. In addition, the present invention also relates to the remote control of other devices as well.

### BACKGROUND OF THE INVENTION

Remote control units or controllers are readily available for a variety of applications from video games and robots, to commercial and military devices requiring a control unit for remote operation of the device's functions. Such devices are generally designed to be stabilized by the operator's positioning of the devices on a table or hard surface, or by holding them with both hands during operation by both hands. For heavier commercial and military applications, the remote controller is often a heavy package of controls and signal relay devices that together is unwieldy for easy use by an operator who must move or be involved in other operations relative to the device being controlled.

There are other remote controllers that are small and hand-held that control devices such as garage doors and TVs that are handy to use for selection of function activation, yet not sufficiently stable in the operator's hand for control of a steering system of a vehicle, for example.

Therefore, it would be advantageous to have a controller device that was ergonomically designed that allowed one-hand operation of complex controls so as to operate dynamic devices with the operator being allowed active movement, or even other function participation, at the same time.

It would be further advantageous if such a controller were small enough to carry readily on one's body with other gear and to “dock” with a carrying position for storage when not in use, or a fixed position on another location or device if desired for fixed location operation.

### SUMMARY OF THE INVENTION

The present invention provides a portable controller for operating a device from a remote location. In one practicable embodiment, the controller includes an elongate body, a manipulable helo type button, and one or more manipulable pushbuttons. The elongate body has an upper portion and a lower portion which together are structurally adapted for one-handed portability. The helo type button is located on the upper portion of the elongate body, and the one or more pushbuttons are located on the lower portion of the elongate body.

In general, the portable controller is constructed in such a way that the controller is comfortable in a human hand, thereby enabling an operator to better grip the controller. In some embodiments, the controller provides positions for each of the hand, thumb, and fingers during operation for control therewith while also allowing them to retain a substantial grip on the controller.

It is to be understood that a top control button having two axis of variability of control signal generation can be operated by one's thumb as is done in helicopter controls, thus simultaneously effecting both a fore-aft drive control and a right-and-left steering control, for example.

The top control button may be designed with surface shape and serrations so as to provide a feel to an operator's thumb allowing a sense of controller orientation such that an operator intuitively knows the directions of the axis of the controls so as to allow operation of the remote controlled device without looking at the device.

The top control button may be positioned within a shielded position provided by the surface structure of the overall controller device such that the top controller button is not caused to be operated inadvertently, while yet allowing a full range of motion of the top button and the operator's thumb during operation.

It is understood that activation of further controls by way of control buttons and switches placed in shielded positions in such ergonomic orientation so as to allow operation by fingers of an operator's hand, not required for general grip of the controller device, may be used to effectuate control of other features of the remote controlled unit being operated by the remoter controller device.

It is to be further understood that shaping of the lower portion of the controller device in a generally tapered manner can allow a snug fit coupling of the generally tapered device within a matching generally tapered receiving device.

The docking of the controller device within the generally tapered receptacle of another device or location allows the mating of the device rigidly onto such device or location for operation of the controller device.

It is to still further be understood that such receptacle of the device could be another controller unit of expanded function, a rigid mount position of the remote device operation, including, but not limited to, being on the remote device itself, or another device of some other function that an operator of the remote device may desire operation of simultaneously with control of the remote controlling device, such as a weapons system in the case of a military application.

Such a remote controller device may be constructed in such a manner that control of other functions relative to its remote control capabilities may be accommodated on the bottom of the device, and operation of such function control may remain operable while docked in a receptacle for mounting of the controller device on another device or location.

Such a hand-held and dockable remote controller device is deemed advantageous for application in operation of remote devices, robotic devices, video games, and vehicles of utility and/or mobility, such as, for example, military weapons system vehicles, military mobility vehicles, agricultural vehicles, construction vehicles, personal transportation vehicles, and utility vehicles.

Furthermore, it is believed that various other alternative embodiments of the present invention will become apparent to those skilled in the art when the detailed description of the best mode(s) contemplated for practicing the present invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a side view of an embodiment of a hand held controller as docked with a device for retention purposes in accordance with one embodiment of the present invention.

FIG. 2 illustrates a rear view of the hand held controller of FIG. 1.

FIG. 3 illustrates a top view of the hand held controller of FIG. 1.

FIG. 4 illustrates a perspective view of the hand held controller of FIG. 1.

FIG. 5 illustrates a perspective view of a hand held controller and retention device in an exploded view in accordance with one embodiment of the present invention.

FIG. 6 illustrates a perspective view of a hand held controller as docked with a device having additional functional controls in accordance with another embodiment of the present invention.

FIG. 7 illustrates a perspective view of a hand held controller as docked with a device having additional functional controls in accordance with another embodiment of the present invention.

FIG. 8 illustrates a perspective view of a hand held controller illustrating the thumb operation of one control element in accordance with an embodiment of the present invention.

FIG. 9 illustrates perspective views of a variety of other embodiments of hand held controllers related to grip, controls shielding, control function and docking in accordance with the present invention.

### LIST OF PARTS AND FEATURES

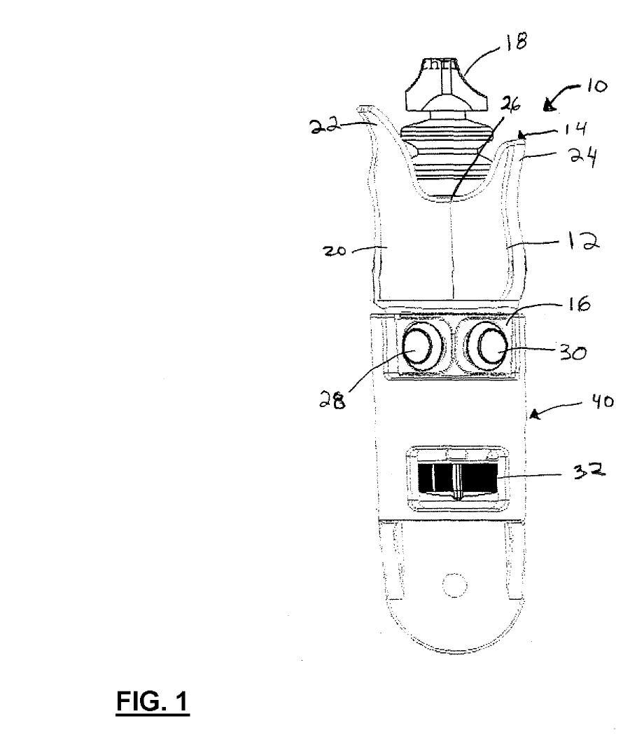

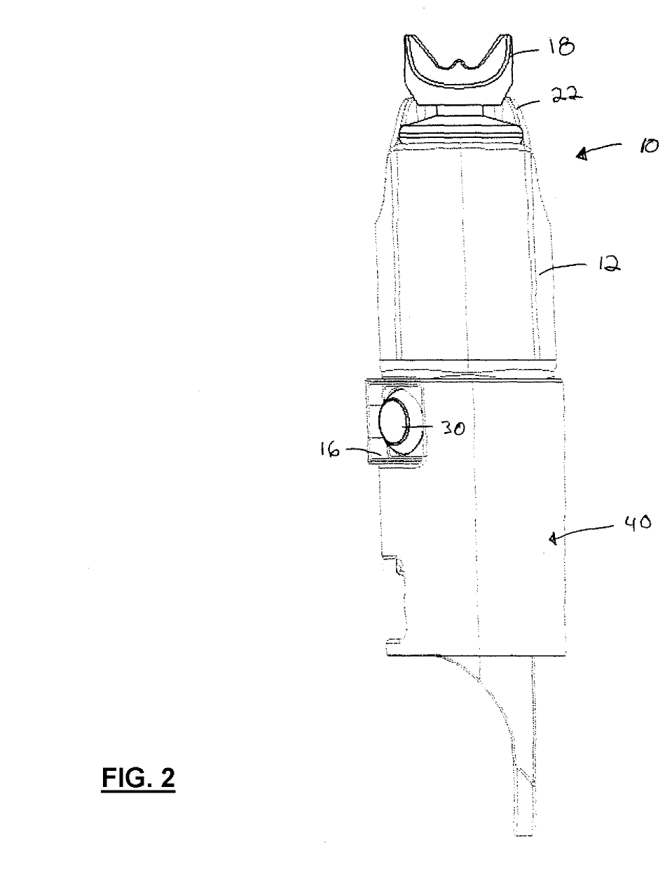

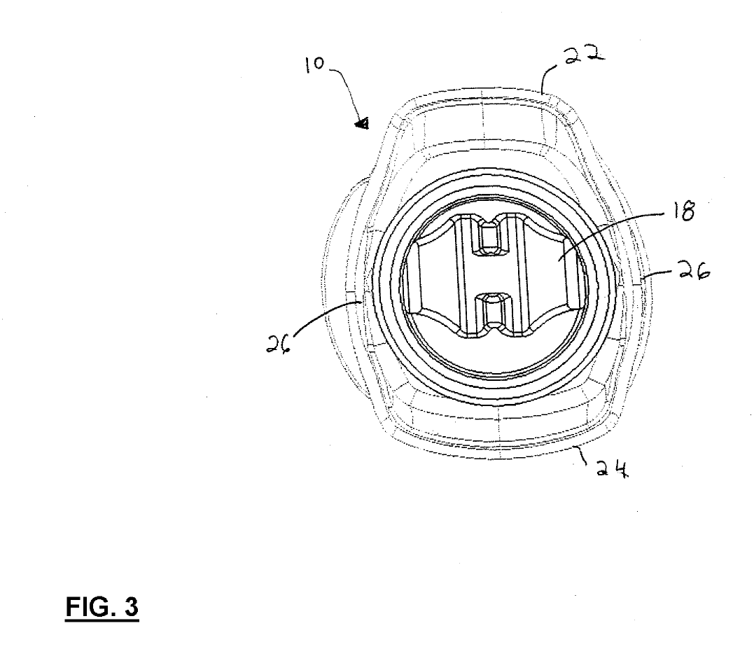

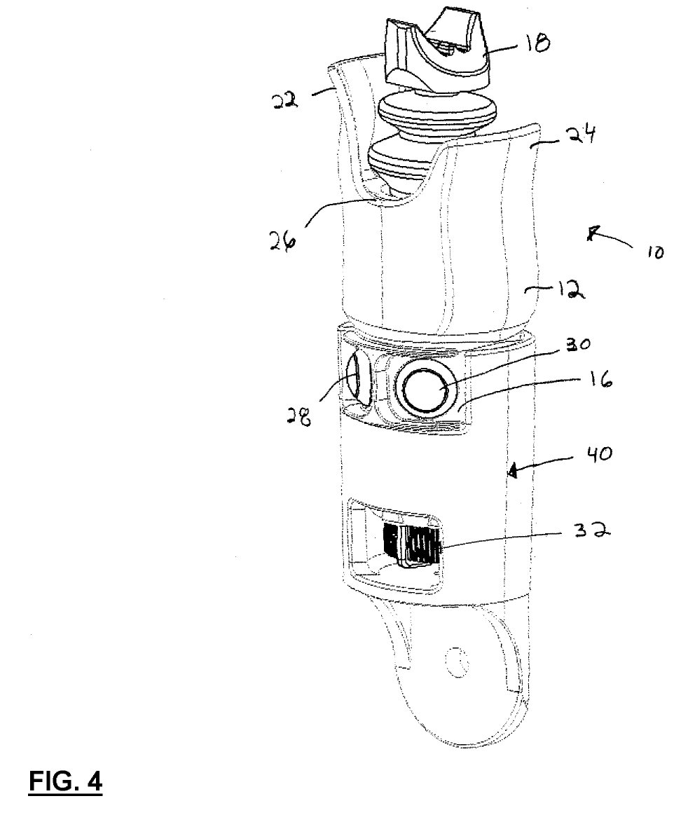

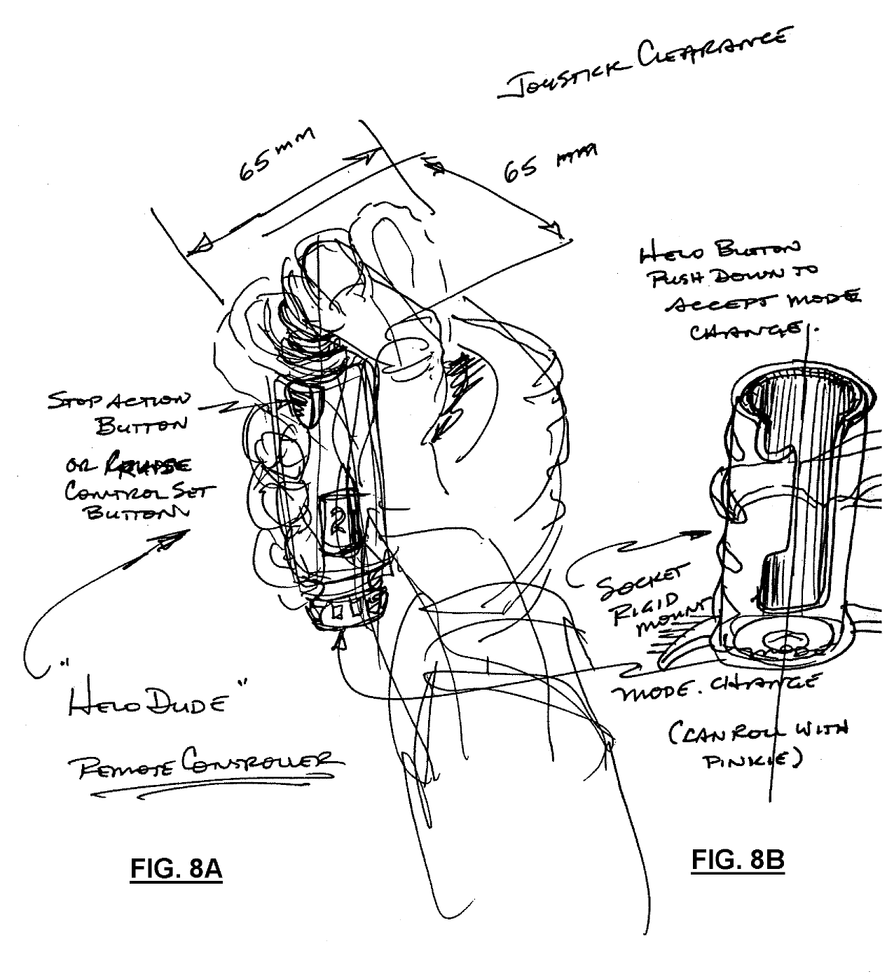

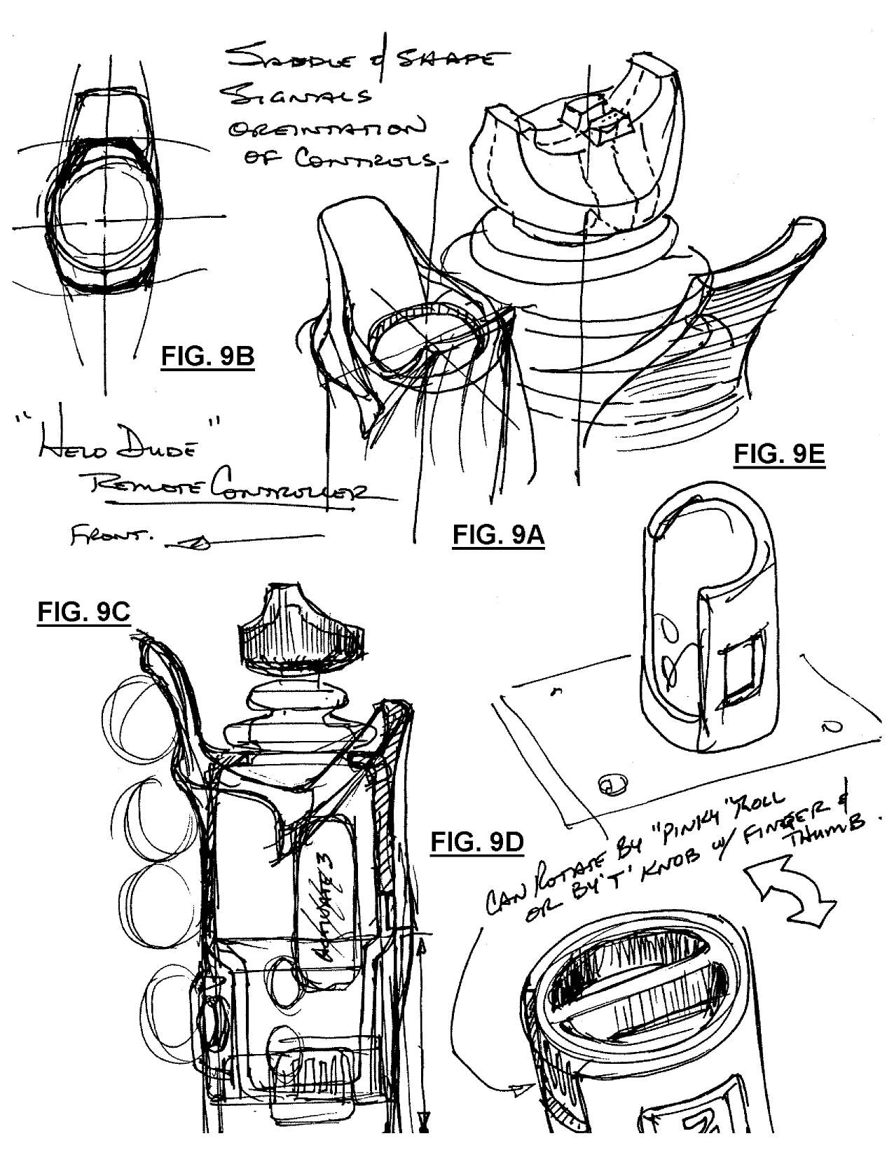

To facilitate a proper understanding of the present invention, a list of parts and features highlighted with alphanumeric designations in FIGS. 1 through 9 is set forth hereinbelow.

10 hand-held controller

12 body portion (of controller)

14 upper portion (of body)

16 lower portion (of body)

18 helo button

20 gripping portion (of body)

22 extended portion (front)

24 extended portion (rear)

26 side portion

28 button (on lower portion)

30 button (on lower portion)

32 rotary switch

40 mating device

46 flange (of mating device)

48 attachment opening

50 docking device

52 expanded controller

### DETAILED DESCRIPTION OF THE INVENTION

FIGS. 1 through 9 illustrate various views and/or embodiments of a hand-held controller 10 in accordance with the present invention. The hand-held controller 10 is preferably utilized to provide remote control of an object or device such as, for example, a vehicle. It is to be understood, however, that the hand-held controller 10 may alternatively be utilized for a variety of other purposes, functions, and/or applications as well.

FIGS. 1 though 4 illustrate one embodiment of the hand-held controller 10. As shown in these figures, the controller 10 includes a body portion 12 that is generally cylindrical in shape. The generally cylindrical body portion 12 allows it to fit easily in the palm of an operator's hand. The body portion 12 itself has an upper portion 14 and a lower portion 16. In one embodiment, the upper portion 14 has a helo-button 18 positioned thereon. The helo-button 18 is preferably positioned such that it projects upwardly from the top surface of the upper portion 14 to thereby allow an operator to move the button 18 with his thumb. The helo-button 18 preferably operates like a joystick in that the operator can manipulate the button 18 by simply moving it with his thumb to effectuate the desired control. It is to be understood, however, that the button 18 may alternatively be positioned in other locations on the body portion 12 of the controller 10 as well. Moreover, the helo-button 18 is preferably positioned such that it is within the reach of an operator's thumb, yet long enough to provide good modulation of control over a device being controlled therewith, such as a vehicle operating at speed with agile steering. The helo-button 18 preferably is configured such that its middle portion of contact is lowered with respect to its side portions. Such a configuration gives an operator tactile feedback as to the orientation of the controller 10 in the operator's hand. This ensures that the operator directs the button 18 as desired in a proper direction.

The upper portion 14 further includes outwardly extending portions 22 and 24 that flare apart and away from the helo-button 18. The extended portion 22 is preferably disposed on the front of the body portion 12 while the extended portion 24 is preferably disposed on the back of the body portion 12. This provides an ergonomic configuration that allows an operator to grab the controller 10 with his fingers high up on the front extended portion 22 and also allows his palm to be braced on the rear extended portion 24 while also allowing his thumb to reach over the rear portion 24 to operate the helo-button 18 while also preventing any inadvertent actuation thereof. The side portions 26 serve to provide side openings to help prevent any object from becoming trapped in the recessed portion, which would interfere with the operation of the button 18. Also, by flaring out the front extended portion 22 and the rear extended portion 24, the helo-button 18 has a relatively large area of motion. Additionally, the button 18 itself is configured such that a portion of it is preferably recessed or set downward with respect to the outwardly extending side portions 22 and 24. This configured combination serves to provide some protection for the button 18 so as to prevent inadvertent contact therewith while also allowing easy access to the button 18 by an operator.

The lower portion 16 includes a plurality of buttons 28 and 30 located on the side of the body portion 12. The lower portion 16 of the body portion 12 has a smaller outer diameter than the gripping portion 20 of the body portion 12 such that the outer diameter of the device when docked within a mating device 40, as further discussed hereinbelow, is generally the same for the length of a hand's grip for allowing an ergonomic grip. Because these buttons 28 and 30 are located on the lower portion 16, they are not disposed on the gripping portion 20 of the body 12 (i.e., the portion intended to be gripped in priority by an operator). Furthermore, their location allows them to be activated by fingers that are not used in gripping the body portion 12. These buttons 28 and 30 provide a plurality of operational controls that can be actuated by the fingers of an operator. Additionally, ribs or covers may be utilized or situated around or over the buttons 28 and 30 for security purposes and/or to prevent inadvertent actuation thereof.

The bottom surface of the body portion 12 includes a rotary switch 32 that can be moved (i.e., adjusted) to a variety of different positions. Each different position allows the controller 10 to control different functions using the same buttons 28 and 30 or 18 for other functions or for activating or regulating another function. For example, when the rotary switch 32 is in one position, it can allow an operator to control a first vehicle. Furthermore, when the rotary switch 32 is moved to another position, it can allow an operator to control a second vehicle. It is to be understood that the rotary switch 32 may be programmed to allow the operator to switch between controlling a variety of different functions of a controlled vehicle or device as desired. Additionally, a small digital display can be incorporated into the body portion 12 of the controller 10 so as to provide status information regarding which mode has been selected for operation by buttons 28, 30, 18, and/or the switch 32. The digital display is thus preferably located near the buttons so as to be visible while an operator grips the controller unit. Furthermore, it is to be understood that the controller 10 may incorporate more than one digital display thereon.

The controller 10 may also include a biometrics assessment means or device, which may be integrated or built in, for example, the grip portion 20. Such a biometrics assessment means may be incorporated into the controller 10 for security purposes and for regulating who may use the remote controller device, which is being used to operate a remote device. The type of biometrics assessment means incorporated in a controller may vary in different embodiments.

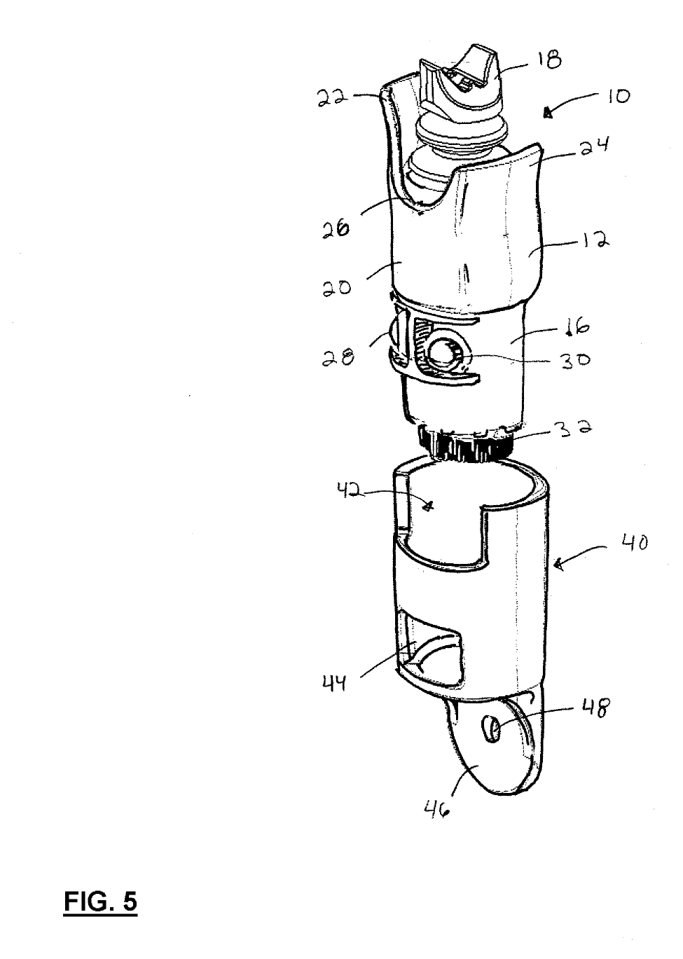

The controller 10 may also be structurally adapted for receipt within a mating device 40. In FIG. 5, the controller 10 is shown separated from the mating device 40. The mating or docking device 40 itself has a hollow interior 42 that is intended to receive the lower portion 16 of the body portion 12. When the controller 10 is properly docked with the mating device 40, the rotary switch 32 is thereby positioned such that it is accessible through an opening 44 that allows an operator to access the rotary switch 32 when the controller 10 is docked. The outer periphery of the mating device 40 has generally the same diameter as the gripping portion 20 to thereby provide ergonomic benefits to an operator. The mating device 40 includes a downwardly extending flange 46 with an attachment opening 48 that allows the docking device 40 to be secured, for example, to a weapon, a vehicle, a belt, or a variety of other devices or locations as desired. Furthermore, it is to be understood that the mating device 40 may also be integral with another device, such as a gun grip or a second controller unit.

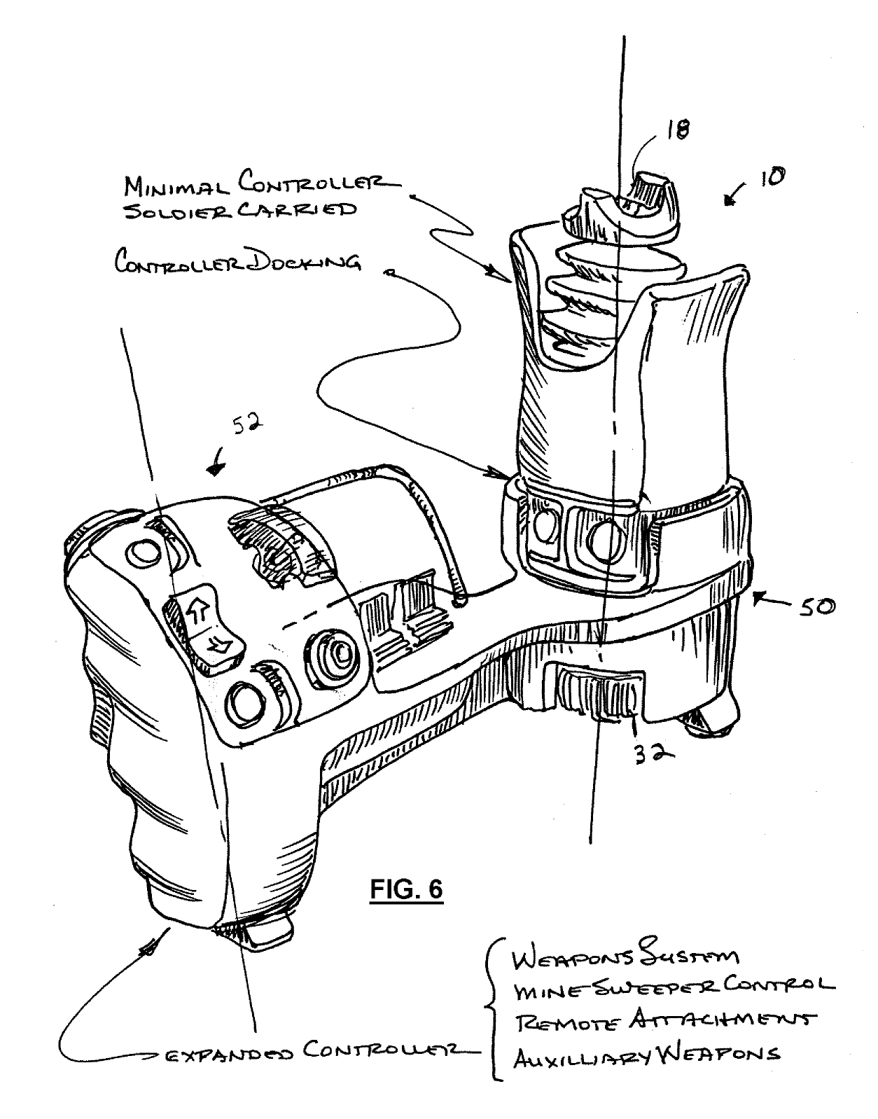

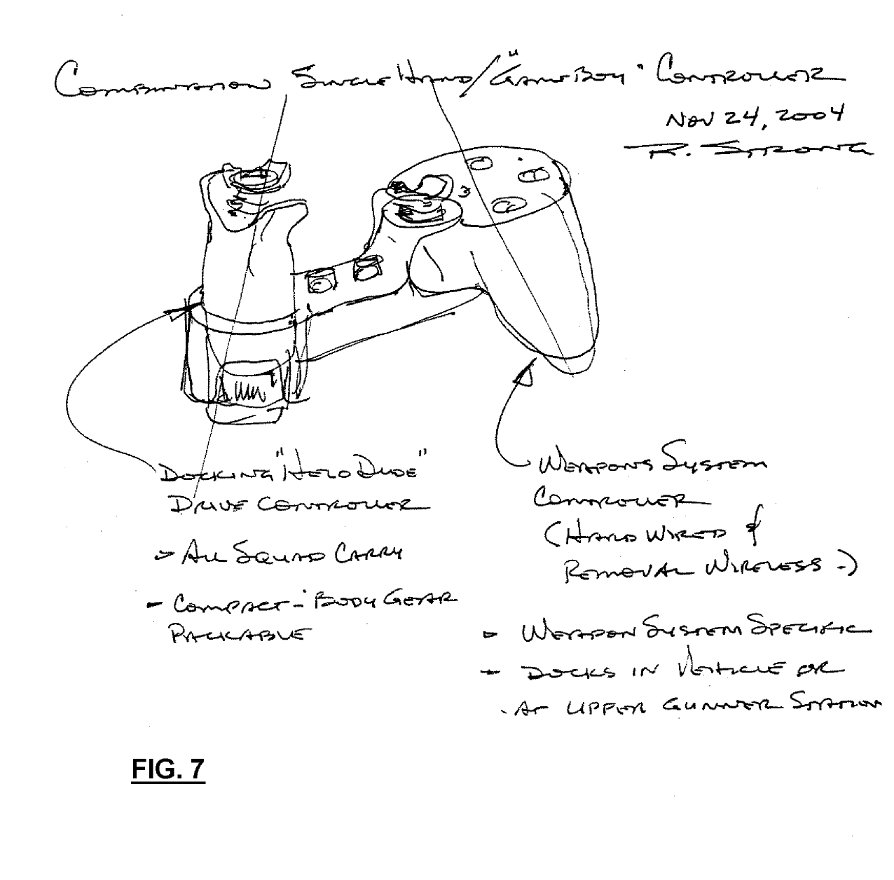

FIGS. 6 and 7 illustrate alternative embodiments of the controller 10 in engagement with a docking device 50 including an expanded controller 52. The expanded controller 52 has a plurality of additional buttons to provide an operator with more control or functionality as desired. For example, in military applications, the expanded controller 52 may include buttons to thereby control, for example, weapons systems, mine sweepers, remote attachments, and/or auxiliary weapons systems.

At least one intended point of novelty in the present invention is the pocketing or recessing of the relatively high motion helicopter switch down in, recessed behind a front grip shield and in front of a back thumb grip shield such that it does not block movement of the switch top itself and provides protection from front and rear unexpected hits. And the side provides opening so that debris does not get in and yet block the switch from operating in any fashion.

Furthermore, the generally round shape of the remote controller or generally its small size allows the controller to fit within an operator's hand while operating the controller, the controller containing switches and the remote controller is dockable to carry on your gear or dockable in a fixed position for operating the vehicle or device, or is dockable with a second unit carrying further controls, a device.

In addition, the controller may also have a multitude of other switches on. The controller can have small displays to show relative status of the device being controlled.

Furthermore, the controller can have rotary knobs or devices to switch control application of the control buttons on the device. The switches or controls on the controller device can have shielding, ribs, or other devices so that they are not accidentally activated.

Still further, the controller device can incorporate biometrics assessment technology so that the controller can only be controlled by a person designated to control the controller.

The controller pursuant to the present invention may be adapted so as to control, for example, a vehicle, a toy, or even a weapons system. In addition, the controller can be operated either right or left-handed for general controls.

Still further, the docking element may have a mounting base that allows it to be based in a multitude of positions. One mounting position, for example, could be on a person's clothing so that it may be on his weapon system. Alternatively, the mounting position may be on the vehicle, or on another area of the vehicle. Still further, the mounting position system may be at a remote site docked with other controllers having functions for equipment operating in conjunction with that controlled by the remote controller.

In addition to the above, the controller can be used for video games, or for a game that incorporates elements of the real device and the real vehicle being operated.

Furthermore, the remote controller may be adapted so that an operator of the remote controller can hold it in one hand and have very good actuation of the switch, that the switch has enough motion for proper control modulation. In addition, the switch top may have a saddle type design so that an operator's thumb fits in the midst of it, and a generally serrated design is provided such that it impresses into its the operator's thumb so that maximum friction is provided to move fore, aft, and sideways. Furthermore, the switch may be adapted so that the orientation of the switch's top shape provides an intuitive sense of orientation for the operator of the controller.

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. A portable controller for operating a device from a remote location, said controller comprising:
an elongate body having an upper portion and a lower portion which together are structurally adapted for one-handed portability;
a manipulable helo type button located on said upper portion of said elongate body; and
at least one manipulable pushbutton located on said lower portion of said elongate body.

2. A portable controller according to claim 1, wherein said device is a vehicle.

3. A portable controller according to claim 1, wherein said device includes at least one item selected from the group consisting of a weapons system, a mine sweeper, a robot, a toy, and a video game.

4. A portable controller according to claim 1, wherein said elongate body has a shape that is substantially cylindrical.

5. A portable controller according to claim 1, wherein said elongate body includes a digital display.

6. A portable controller according to claim 1, wherein said upper portion of said elongate body includes a gripping portion adapted for holding in a single human hand.

7. A portable controller according to claim 6, wherein said gripping portion includes a biometrics assessment device.

8. A portable controller according to claim 1, wherein said lower portion of said elongate body includes a rotary switch adapted for manipulation with a human finger.

9. A portable controller according to claim 1, wherein said helo type button is particularly located on the top distal end of said upper portion of said elongate body.

10. A portable controller according to claim 1, wherein said helo type button has structure adapted for manipulation with a human thumb.

11. A portable controller according to claim 1, wherein said helo type button has a recessed middle portion and two upwardly extending side portions for fitting about a human thumb.

12. A portable controller according to claim 1, wherein each said pushbutton is respectively designated for controlling at least one operational aspect of said device.

13. A portable controller according to claim 1, wherein said elongate body is structurally adapted for being received in a docking device associated with another controller.

14. A portable controller according to claim 1, wherein said elongate body is structurally adapted for being received in a docking device associated with another controller for electrical communication therewith.

15. A portable controller for operating a device from a remote location, said controller comprising:
an elongate body having an upper portion and a lower portion which together are structurally adapted for one-handed portability;
a manipulable helo type button located on said upper portion of said elongate body; and
at least one manipulable pushbutton located on said lower portion of said elongate body;
whereby said device can be controlled remotely with a single human hand.

16. A portable controller according to claim 15, wherein said elongate body includes a digital display.

17. A portable controller according to claim 15, wherein said elongate body includes a biometrics assessment device.

18. A portable controller according to claim 15, wherein said lower portion of said elongate body includes a rotary switch adapted for manipulation with a human finger.

19. A portable controller according to claim 15, wherein said elongate body is structurally adapted for being received in a docking device associated with another controller.

20. A portable controller for operating a device from a remote location, said controller comprising:
an elongate body having an upper portion and a lower portion which together are structurally adapted for one-handed portability;
a manipulable helo type button located on said upper portion of said elongate body; and
a plurality of manipulable pushbuttons located on said lower portion of said elongate body;
whereby said device can be controlled remotely with a single human hand.
